(19) United States
(12) Patent Application Publication
(10) Pub. No.: US 2015/0109754 A1
(43) Pub. Date: Apr. 23, 2015

(54) STROBE DEVICE AND IMAGE PICK-UP DEVICE PROVIDED WITH SAME

(71) Applicant: Panasonic Intellectual Property Management Co., Ltd., Osaka (JP)

(72) Inventors: Toshiaki Takenaka, Osaka (JP); Kazuhiko Ooyama, Hyogo (JP); Yoshimi Fukuda, Osaka (JP)

(73) Assignee: Panasonic Intellectual Property Management Co., Ltd., Osaka (JP)

(21) Appl. No.: 14/395,107

(22) PCT Filed: Apr. 18, 2013
(86) PCT No.: PCT/JP2013/002614

§ 371 Date: Oct. 17, 2014

(30) Foreign Application Priority Data
Apr. 25, 2012 (JP) 2012-099474

(51) Int. Cl. G03B 15/05; F21V 14/02

(52) U.S. Cl. CPC G03B 15/05; F21V 14/02; F21W 2111/10
USPC 362/4

(57) ABSTRACT

The present invention relates to a strobe device including: a strobe main body; a light emitter rotatably coupled to the strobe main body; a variable mechanism capable of changing an illumination direction angle of the light emitter; and a driver-that drives the variable mechanism. The driver includes: a detector that detects that abnormal force is applied to the variable mechanism and a detection responsive controller that controls the driver based on the abnormal force detected by the detector. This can achieve the strobe device that can prevent the light emitter from colliding with an obstacle and prevent the driver from being damaged.

### TECHNICAL FIELD

The present invention relates to a strobe device which controls an illumination range in which a flash discharge tube emits light and an image pick-up device including the strobe device.

### BACKGROUND ART

Conventionally, to obtain a more natural image, an image pick-up device including a strobe device has performed bounce photography. In the bounce photography, when a reflection body such as a ceiling or a wall is illuminated by strobe light emitted from the light emitter of the strobe device, the strobe light is diffused, thereby allowing a subject to be indirectly illuminated and photographed.

That is, in the bounce photography, the illumination surface of the light emitter of the strobe device does not face the subject, but is oriented in the desired direction in which the reflection body such as the ceiling or the wall is located. In this state, the strobe light is reflected off the reflection body, to illuminate and photograph the subject.

Thus, a conventional strobe device is suggested which the controller of the strobe device automatically controls a bounce angle formed by (i) a direction in which a subject is to be photographed, i.e., the optical axis direction of an imaging lens and (ii) a direction in which a reflection body is to be illuminated by strobe light (i.e., the desired direction in which the reflection body is located) (e.g., Patent Literature 1). This can always direct the light emitter of the strobe device toward the direction in which the reflection body is located and indirectly illuminate the subject.

However, the strobe device disclosed in Patent Literature 1 (PTL 1) controls a bounce angle by automatically moving a light emitter. Thus, PTL 1 has the following problems. For instance, during photographing with the light emitter of the strobe device set in a camera, the light emitter of the strobe device collides with the head of a photographer looking through the finder of the camera, thereby decreasing safety. Moreover, the light emitter collides with an obstacle other than the photographer, damaging a driver which controls the bounce angle. As yet another problem, the collision with the photographer or the obstacle blemishes the exterior surface of the strobe device.

Meanwhile, when the bounce angle is adjusted to a desired angle manually by the photographer rather than by automatic control, there is a need to move the light emitter with very strong force. This causes a problem in operability. As another problem, too strong force applied to, for example, the light emitter damages the driver which controls the bounce angle.

### CITATION LIST

### Patent Literature

PTL 1: Unexamined Japanese Patent Application Publication No. 2009-163179

### SUMMARY OF THE INVENTION

To solve the above problems, the present invention includes: a strobe main body; a light emitter rotatably coupled to the strobe main body; a variable mechanism capable of changing an illumination direction angle of the light emitter; and a driver that drives the variable mechanism, in which the driver includes: a detector that detects that abnormal force is applied to the variable mechanism; and a detection responsive controller that controls the driver based on the abnormal force detected by the detector.

This can prevent the light emitter from being damaged and achieve a strobe device with excellent safety and reliability.

Moreover, the present invention may include: a strobe main body; a light emitter rotatably coupled to the strobe main body; a variable mechanism capable of changing an illumination direction angle of the light emitter; and a driver that drives the variable mechanism, in which the driver includes: an obstacle detector that detects that the light emitter is going to collide with an obstacle; and a detection responsive controller that controls the driver when the obstacle detector detects that the light emitter is going to collide with the obstacle.

Thus, an obstacle can be detected before the light emitter collides with the obstacle. This can not only prevent a person such as a photographer from being placed in danger or decrease the danger, but also prevent a variable mechanism from being damaged. As a result, the strobe device with excellent safety and reliability can be achieved.

Moreover, the image pick-up device in the present invention may include the above strobe device. This can improve safety and achieve an image pick-up device with excellent reliability.

### BRIEF DESCRIPTION OF DRAWINGS

FIG. 1 is a block diagram illustrating the configuration of an image pick-up device according to a first exemplary embodiment of the present invention.

FIG. 2 is a side view of a strobe device according to the first exemplary embodiment.

FIG. 3 is a top view of the strobe device according to the first exemplary embodiment.

FIG. 4A is a figure for explaining an illumination range in the vertical direction in which the strobe device according to the first exemplary embodiment can be set.

FIG. 4B is a figure for explaining an illumination range in the horizontal direction in which the strobe device according to the first exemplary embodiment can be set.

FIG. 5 is a figure for explaining an example of the inclination angle of the strobe device according to the first exemplary embodiment in a bounce photographing mode.

FIG. 6 is a flowchart illustrating a procedure by the strobe device according to the first exemplary embodiment in the bounce photographing mode.

FIG. 7 is a side view of a strobe device according to a second exemplary embodiment of the present invention.

### DESCRIPTION OF EMBODIMENTS

The following describes strobe devices in the embodiments of the present invention with reference to the drawings. It should be noted that the following exemplary embodiments are mere examples obtained by embodying the present invention. Thus, the exemplary embodiments do not limit the technical scope of the present invention.

### First Exemplary Embodiment

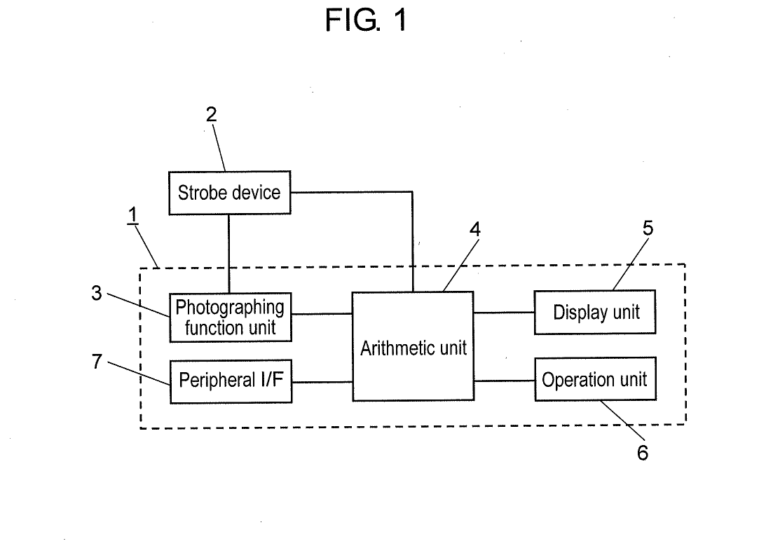

With reference to FIGS. 1 to 4B, the strobe device in an exemplary embodiment of the present invention will be described.

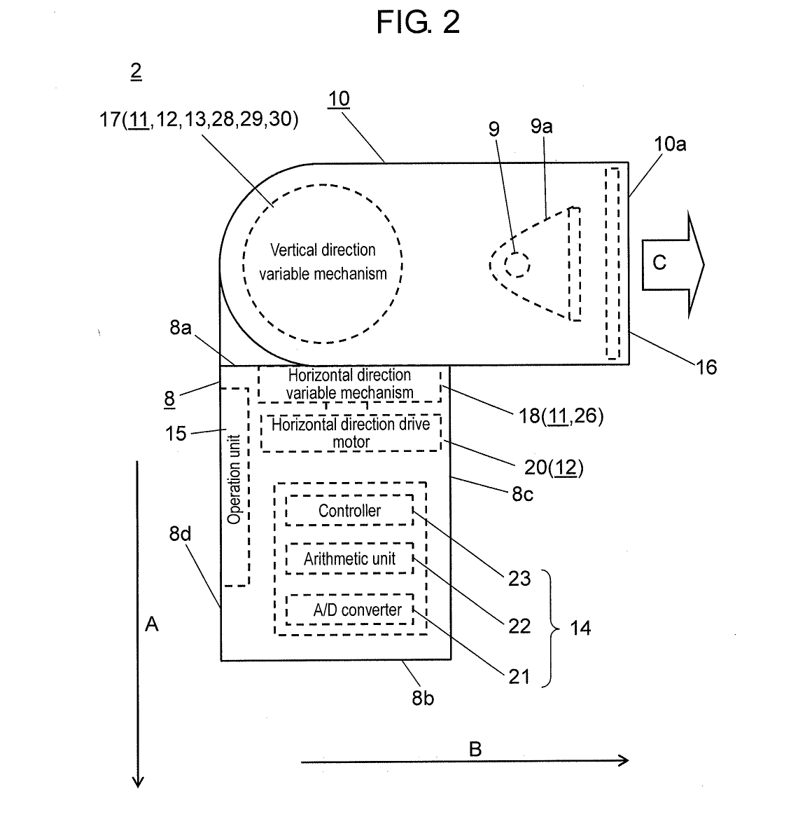

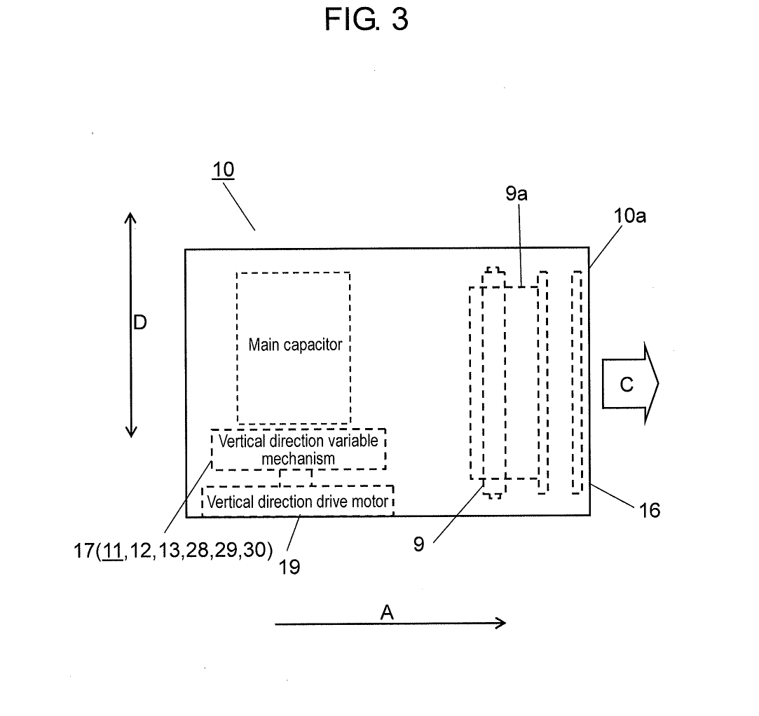

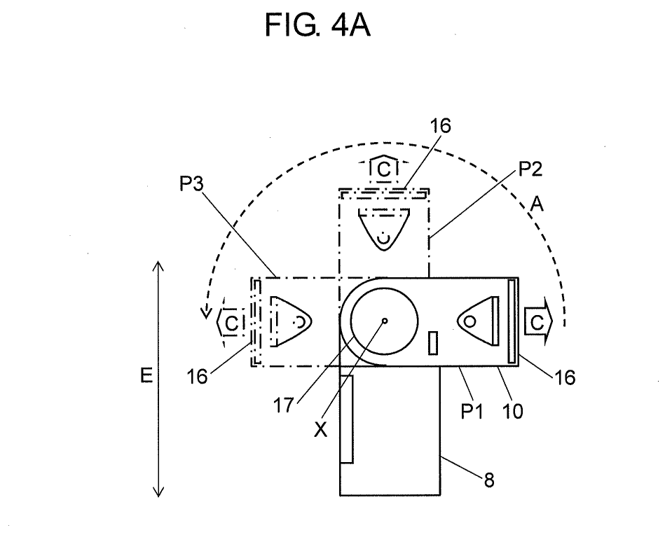

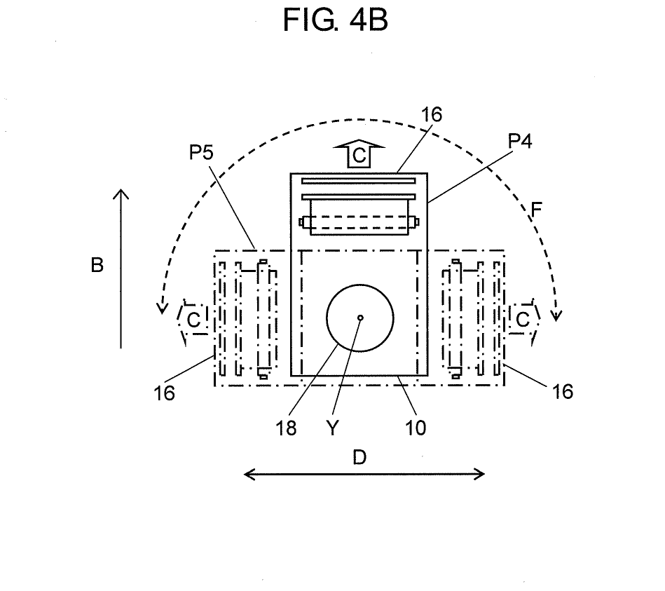

FIG. 1 is a block diagram illustrating the configuration of an image pick-up device according to a first exemplary embodiment of the present invention. FIG. 2 is a side view of a strobe device according to the first exemplary embodiment. FIG. 3 is a top view of the strobe device according to the first exemplary embodiment. FIG. 4A is a figure for explaining an illumination range in the vertical direction in which the strobe device according to the first exemplary embodiment can be set. FIG. 4B is a figure for explaining an illumination range in the horizontal direction in which the strobe device according to the first exemplary embodiment can be set.

As FIG. 1 illustrates, image pick-up device 1 according to the present exemplary embodiment includes at least photographing function unit 3 for photographing a subject, arithmetic unit 4, display unit 5, operation unit 6, and peripheral interface (I/F) 7. Moreover, image pick-up device 1 includes attachable (detachable) strobe device 2 for illuminating a subject with strobe light.

Arithmetic unit 4 controls strobe device 2 and photographing function unit 3. Display unit 5 displays, for example, an image showing the subject. Operation unit 6 sets the photographing conditions and switches the power ON/OFF. Peripheral I/F 7 inputs or outputs, for example, image data between image pick-up device 1 and peripheral equipment.

Moreover, as FIGS. 2 and 3 illustrate, strobe device 2 according to the present exemplary embodiment includes at least strobe main body 8 which is a rectangular-shaped housing, light emitter 10, variable mechanism 11, driver 12, vertical direction angle detector 13, control device 14, and operation unit 15, for example. Light emitter 10 is rotatably coupled to strobe main body 8 and houses flash discharge tube 9. Light emitter 10 reflects light emitted from flash discharge tube 9 off reflector 9a, to emit the light externally through opening 16 on the illumination surface side. Variable mechanism 11 changes the angle of light emitter 10 to a desired angle. Driver 12 drives variable mechanism 11. Vertical direction angle detector 13 detects the angle in vertical direction A of light emitter 10 (see FIG. 2). Control device 14 causes driver 12 to change the angle in vertical direction A of light emitter 10, based on a detection signal from vertical direction angle detector 13. Here, driver 12 includes, for example, vertical direction drive motor illustrated in FIG. 3. Operation unit 15 is provided in strobe main body 8. A user can set, for example, a desired illumination direction angle of light emitter 10 via operation unit 15.

Moreover, light emitter 10 is rotatably coupled on the side where top face 8a of strobe main body 8 is located. Furthermore, image pick-up device 1 illustrated in FIG. 1 is connectably provided on the side where bottom face 8b of strobe main body 8 is located. Here, strobe main body 8 is coupled to image pick-up device 1 so as to direct front 8c of strobe main body 8 in photographing direction B in which image pick-up device 1 photographs (the optical axis direction of an imaging lens).

Moreover, light emitter 10 is a housing having, for example, a substantially-rectangular shape, and has, on the side where face 10a, which is one of the faces of the housing, is located, opening 16 through which light emitted from flash discharge tube 9 is emitted. It should be noted that the substantially-rectangular shape includes a rectangular shape. In light emitter 10, illumination direction C in which strobe light is to be emitted can be changed by changing the angle of opening 16 with respect to vertical direction A via variable mechanism 11.

Moreover, as FIGS. 2 and 4B illustrate, variable mechanism 11 includes vertical direction variable mechanism 17 and horizontal direction variable mechanism 18. Variable mechanism 11 rotatably couples strobe main body 8 and light emitter 10. Specifically, vertical direction variable mechanism 17 of variable mechanism 11 is coupled to strobe main body 8 rotatably around lateral axis X in vertical direction A. Here, lateral axis X is along width direction D of strobe main body 8 (see FIG. 3). Meanwhile, horizontal direction variable mechanism 18 of variable mechanism 11 is coupled to light emitter 10 rotatably around vertical axis Y in horizontal direction F. Here, vertical axis Y is along vertical direction E (height direction, see FIG. 4A) of strobe main body 8.

Furthermore, vertical direction variable mechanism 17 of variable mechanism 11 is rotatably coupled to strobe main body 8 in a rotation angle range from a normal illumination direction angle which is the angle of light emitter 10 in vertical direction A illustrated in the solid line in FIG. 4A to desired illumination direction angles which are different from the normal illumination direction angle, set by a user, and illustrated in the alternate long and short dash lines in FIG. 4A. (Here, the normal illumination direction angle is the angle at which light emitter 10 is positioned at normal photographing position P1. The desired illumination direction angles are the angles at which light emitter 10 is positioned at bounce photographing positions P2 and P3.) In this case, vertical direction variable mechanism 17 of variable mechanism 11 rotates between normal photographing position P1 and bounce photographing position P3, for example, in a rotation angle range of 180 degrees in the vertical direction.

Meanwhile, horizontal direction variable mechanism 18 of variable mechanism 11 rotates in a rotation angle range of 180 degrees in the horizontal direction. Here, the center position is light emitter 10 illustrated in the solid line in FIG. 4B

Moreover, as FIGS. 2 and 3 illustrate, driver 12 includes vertical direction driver 19 (see FIG. 3) and horizontal direction driver 20 (see FIG. 2). Vertical direction driver 19 includes, for example, a vertical direction drive motor, and rotationally drives vertical direction variable mechanism 17. Horizontal direction driver 20 includes, for example, a horizontal direction drive motor, and rotationally drives horizontal direction variable mechanism 18.

Moreover, in the present exemplary embodiment, vertical direction angle detector 13 includes, for example, a variable resistor. The resistance value of the variable resistor varies along with a change in angle in the vertical direction of light emitter 10. The angle in the vertical direction of light emitter 10 with respect to strobe main body 8 (the orientation of light emitter 10) is detected from a change in voltage value resulted from a variance in resistance value of the variable resistor.

Furthermore, vertical direction angle detector 13 includes detector 28 for detecting that abnormal force has been applied to variable mechanism 11. Detector 28 includes direction detector 29 for detecting the direction in which the abnormal force is applied.

Moreover, as FIG. 2 illustrates, control device 14 includes at least AID converter 21, arithmetic unit 22, controller 23 for controlling driver 12, and detection responsive controller 30. A/D converter 21 performs A/D conversion on a detection signal from vertical direction angle detector 13. Arithmetic unit 22 calculates a difference in inclination angle between the current angle of light emitter 10 and a desired illumination direction angle, based on a conversion value obtained through the conversion by A/D converter 21 and a specified value for the desired illumination direction angle. Controller 23 controls driver 12 so as to eliminate the difference in inclination angle between the current angle of light emitter 10 and a desired illumination direction angle calculated by arithmetic unit 22. If detector 28 detects abnormal force, detection responsive controller 30 controls driver 12. That is, control device 14 changes the angle in vertical direction A of light emitter 10, at least, from the current inclination angle to the desired illumination direction angle.

Furthermore, control device 14 can switch between photographing modes such as between a normal photographing mode and a bounce photographing mode. That is, in the normal photographing mode, control device 14 sets the inclination angle of light emitter 10 to the normal illumination direction angle so that strobe light is emitted in photographing direction B (the direction in which a subject is present). Meanwhile, in the bounce photographing mode, control device 14 sets the inclination angle of light emitter 10 to a desired illumination direction angle so that strobe light is emitted in a particular direction set by a user (If a subject should be indirectly illuminated, the particular direction is the direction in which a reflection body such as a ceiling is located). This can change the inclination angle of light emitter 10 to the desired illumination direction angle in response to the selected normal photographing mode or bounce photographing mode, and illuminate the subject.

Moreover, operation unit 15 is provided on back 8d (the face opposite to the side on which the subject is present) of strobe main body 8. Operation unit 15 sets the desired illumination direction angle for arithmetic unit 22 of control device 14 by vertical direction angle detector 13 detecting an inclination angle when strobe device 2 (or only light emitter 10) is inclined to have the desired illumination direction angle. That is, light emitter 10 is rotated to have an angle desired by the user. Vertical direction angle detector 13 detects the angle in the vertical direction of light emitter 10. By storing the detected value, operation unit 15 associates the desired illumination direction angle of light emitter 10 desired by the user and the angle in the vertical direction of light emitter 10, and sets the desired illumination direction angle for arithmetic unit 22.

With reference to FIGS. 2, 5, and 6, the following describes an operation by image pick-up device 1 according to the present exemplary embodiment in the bounce photographing mode.

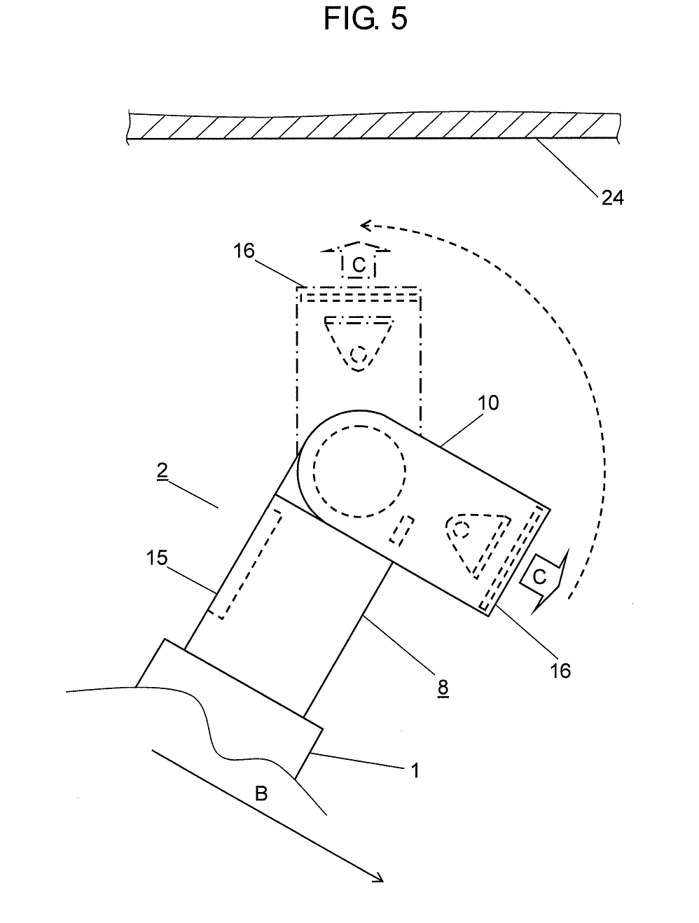

FIG. 5 is a figure for explaining an example of the inclination angle of the strobe device according to the present exemplary embodiment in the bounce photographing mode.

It should be noted that the following introduces, as an example, the case where the normal photographing mode is selected as the initial state of strobe device 2 and illumination direction C of light emitter 10 of strobe device 2 is inclined to be oriented in photographing direction B as illustrated in FIG. 5 (this state corresponds to the state where the light emitter 10 is positioned at normal photographing position P1 illustrated in FIG. 4A).

As FIGS. 2 and 5 illustrate, the user sets, for control device 14, a desired illumination direction angle in the bounce photographing mode, by the following way.

Specifically, the user directs opening 16 of light emitter 10 toward reflection body 24 (a ceiling plane in the present exemplary embodiment) to be illuminated by strobe light in the bounce photographing mode. Here, operation unit 15 causes vertical direction angle detector 13 to detect the angle of light emitter 10 with respect to vertical direction A in the above state. Vertical direction angle detector 13 inputs a detection signal corresponding to the angle of light emitter 10, to A/D converter 21 of control device 14. A/D converter 21 then performs A/D conversion on the detection signal. Furthermore, a conversion value obtained through the A/D conversion is inputted to arithmetic unit 22 of control device 14. Arithmetic unit 22 of control device 14 prestores the conversion value inputted from A/D converter 21 as a specified value for a desired illumination direction angle of light emitter 10 in the bounce photographing mode.

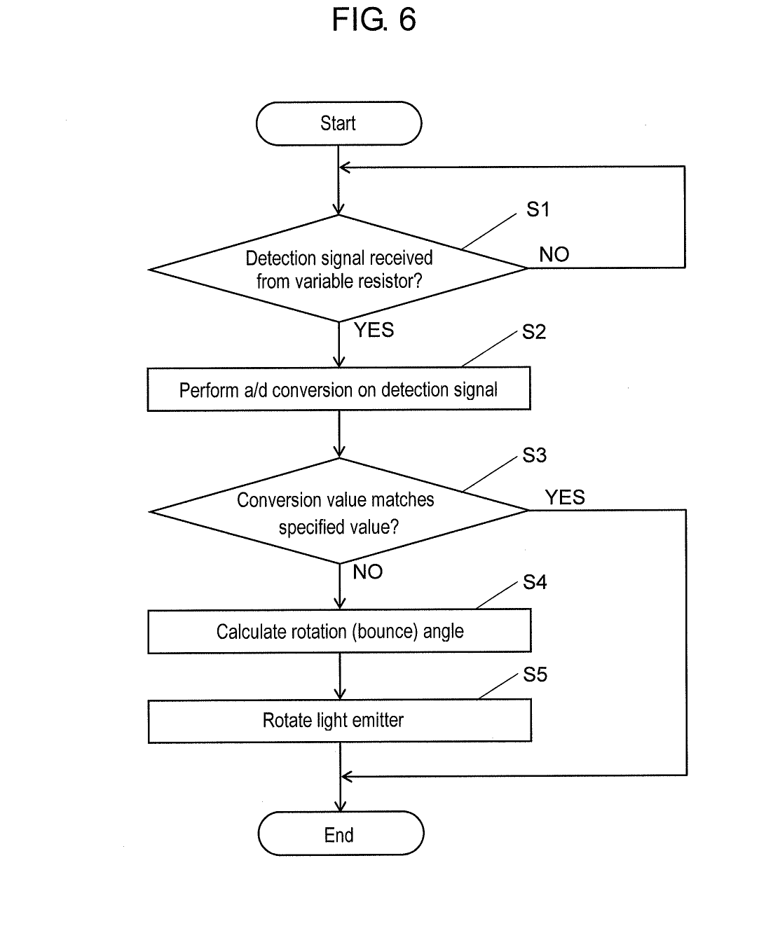

With reference to FIG. 6, the following describes the case where the user selects the bounce photographing mode and photographs a subject in the bounce photographing mode while the specified value for the desired illumination direction angle of light emitter 10 is prestored as described above.

FIG. 6 is a flowchart illustrating a procedure by the strobe device according to the present exemplary embodiment in the bounce photographing mode.

The user releases the shutter with the imaging lens of image pick-up device 1 pointed in the subject, and starts photographing. Here, if the current angle in the vertical direction of strobe device 2 is different from the stored specified value for the desired illumination direction angle, light emitter 10 is rotated (bounced) to have the desired illumination direction angle so that the strobe light illuminates reflection body 24 (ceiling).

Specifically, as FIGS. 2 and 6 illustrate, whether or not vertical direction angle detector 13 has detected a detection signal is determined (step S1). Here, if vertical direction angle detector 13 has detected the detection signal (Yes in step S1), the angle in vertical direction A of light emitter 10 is detected. A/D converter 21 performs A/D conversion on the detection signal detected by vertical direction angle detector 13 (step S2). Meanwhile, if vertical direction angle detector 13 has not detected the detection signal (No in step S1), detection of the detection signal by vertical direction angle detector 13 is waited for.

Arithmetic unit 22 of control device 14 determines whether or not a conversion value inputted from A/D converter 21 matches a specified value for an inclination angle corresponding to the desired illumination direction angle preset above (step S3).

Here, if the conversion value does not match the specified value (No in step S3), arithmetic unit 22 of control device 14 calculates a rotation (bounce) angle (step S4).

Specifically, arithmetic unit 22 of control device 14 calculates an angle difference between the conversion value and the specified value for the inclination angle corresponding to the desired illumination direction angle (a difference in inclination angle between the current angle of light emitter 10 and a desired illumination direction angle).

The calculated difference in inclination angle is inputted as a rotation angle to controller 23 of control device 14.

Controller 23 of control device 14 rotates light emitter 10 by the rotation angle corresponding to the difference in inclination angle, from the inputted current angle of light emitter 10 (step S5).

When the difference in inclination angle between the current angle of light emitter 10 and a desired illumination direction angle is eliminated (specifically, when the conversion value matches the specified value), bounce processing for light emitter 10 is completed.

Meanwhile, if the conversion value matches the specified value (Yes in step S3), controller 23 of control device 14 completes the bounce processing for light emitter 10 without changing the angle of light emitter 10.

According to the present exemplary embodiment, control device 14 can immediately change the angle of light emitter 10 to a desired illumination direction angle, based on the angle in the vertical direction of light emitter 10 automatically detected by vertical direction angle detector 13, independently of the current angle of strobe device 2 (the angle of strobe device 2 before photographing).

More specifically, control device 14 causes A/D converter 21 to convert a detection signal automatically detected by vertical direction angle detector 13. Subsequently, arithmetic unit 22 of control device 14 calculates a difference in inclination angle between the current angle of light emitter 10 and the desired illumination direction angle, based on a conversion value obtained through the conversion by A/D converter 21 and a preset specified value for the desired illumination direction angle. Control device 14 controls driver 12 of control device 14 (vertical direction driver 19 in the present exemplary embodiment) such that controller 23 eliminates the difference in inclination angle between the current angle of light emitter 10 and the desired illumination direction angle (such that the conversion value matches the specified value). This can immediately change the inclination angle of light emitter 10 to the desired illumination direction angle.

Moreover, according to the present exemplary embodiment, the inclination angle in vertical direction A of light emitter 10 can be immediately detected by using a variable resistor as vertical direction angle detector 13. As a result, control device 14 can immediately change the angle of light emitter 10 to the desired illumination direction angle, independently of the current inclination angle in vertical direction A of strobe device 2.

Moreover, according to the present exemplary embodiment, the user can arbitrarily preset, using operation unit 15, the desired illumination direction angle in vertical direction A of light emitter 10. This can easily change the inclination angle of light emitter 10 to the desired illumination direction angle set by operation unit 15.

The following specifically describes an operation when abnormal force is applied to the light emitter of the strobe device in the present exemplary embodiment, which is a point of the present invention.

As an example in which abnormal force is applied to light emitter 10, the following introduces the case where when light emitter 10 is not in operation, a photographer or others, for example, applies force to light emitter 10, trying to forcibly adjust the angle of light emitter 10 to a desired angle with her/his hand.

In this case, too large force applied to light emitter 10 causes a malfunction such as damage to the gear of vertical direction variable mechanism 17.

In view of this, when the abnormal force is applied to light emitter 10, the strobe device operates as follows to prevent the gear or others from being damaged.

That is, when the abnormal force is applied to light emitter 10, light emitter 10 moves by a backlash of the gear of vertical direction variable mechanism 17. Here, the resistance value of a variable resistor included in the detector 28 of vertical direction angle detector 13 is changed from the resistance value before the force is applied to light emitter 10. In response to the change in resistance value, a voltage value to be outputted changes. Because of this, that force has been applied to light emitter 10 is detected. Moreover, the direction in which the force has been applied can be determined based on fluctuations (an increase or decrease) in voltage to be outputted, from the voltage value before the force is applied to light emitter 10.

For instance, when vertical direction angle detector 13 detects that force for moving light emitter 10 is applied in vertical direction A illustrated by an arrow in FIG. 4A, detection responsive controller 30 controls vertical direction variable mechanism 17 so that vertical direction variable mechanism 17 moves light emitter 10 in vertical direction A. This prevents vertical direction variable mechanism 17 from being damaged by releasing the applied force before the gear is damaged.

Moreover, when vertical direction angle detector 13 no longer detects the force applied to light emitter 10 (there is no voltage change) from the movement in vertical direction A of light emitter 10, detection responsive controller 30 controls vertical direction variable mechanism 17 so that vertical direction variable mechanism 17 stops light emitter 10 from moving. This can not only prevent the gear from being damaged, but also assist the force which is applied to light emitter 10 when the photographer manually adjusts the angle of light emitter 10. As a result, the angle of light emitter 10 can be easily changed with the small force.

As an example of the case where abnormal force is applied to light emitter 10, the following describes operations when the abnormal force is applied to light emitter 10 in operation.

Specifically, when the angle of light emitter 10 is changed in the bounce photographing mode, light emitter 10 may collide with the head of a person holding image pick-up device 1 or a fixed thing (obstacle) such as a wall during the automatic operation of light emitter 10.

In this case, vertical direction variable mechanism 17 tries to operate until light emitter 10 has a desired angle through movement. This ultimately causes a malfunction such as damage to the gear of vertical direction variable mechanism 17.

That is, when the force for stopping the operation of light emitter 10 works, the resistance value of a variable resistor in detector 28 (voltage) does not change even if control device 14 outputs a signal for operating vertical direction variable mechanism 17. This stops the operation of light emitter 10 and detects that light emitter 10 is not moving.

Moreover, if light emitter 10 does not reach a predetermined position within a normally expected operation time for some reasons, the resistance value of the variable resistor (a voltage) at the position which light emitter 10 should have reached is not outputted. This can detect that light emitter 10 is not in operation.

Here, when it is detected that light emitter 10 is not in operation, detection responsive controller 30 stops light emitter 10 from moving. Alternatively, detection responsive controller 30 controls vertical direction variable mechanism 17 so that vertical direction variable mechanism 17 moves light emitter 10 in a direction opposite to the movement direction of light emitter 10 before light emitter 10 stops moving.

This can eliminate or release the force applied to the gear (reaction from an obstacle) before the gear is damaged. This prevents vertical direction variable mechanism 17 from being damaged.

### Second Exemplary Embodiment

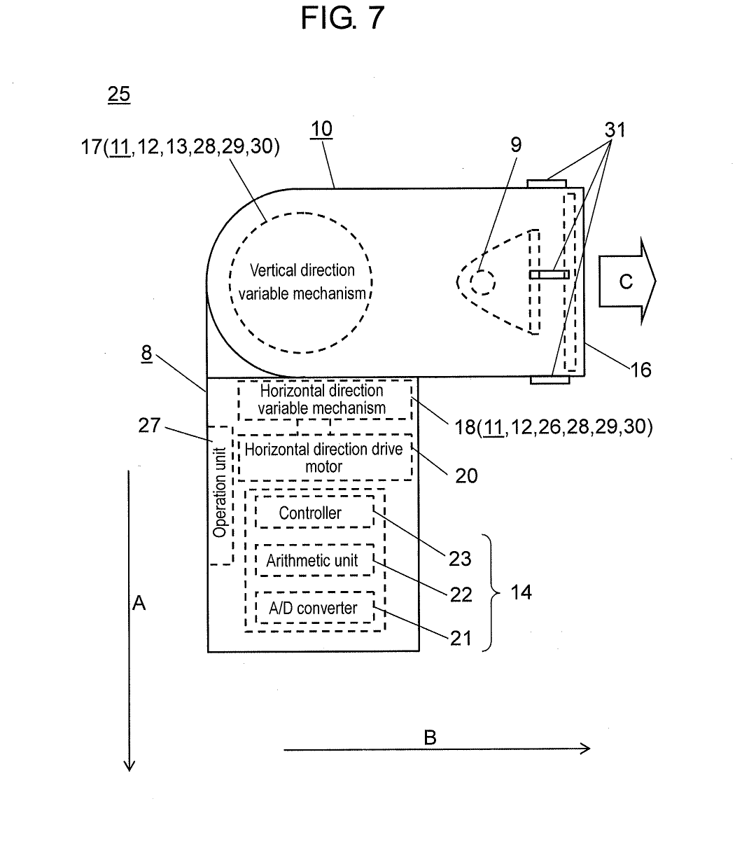

With reference to FIG. 7, the following describes a strobe device and an image pick-up device including the strobe device according to a second exemplary embodiment of the present invention.

FIG. 7 is a side view of the strobe device according to a second exemplary embodiment of the present invention.

That is, strobe device 25 according to the present exemplary embodiment is different from strobe device 2 according to the first embodiment in that strobe device 25 further includes horizontal direction angle detector 26.

The following description focuses on horizontal direction angle detector 26 included in strobe device 25 in the present exemplary embodiment. It should be noted that other configuration or function are basically similar to those of strobe device 2 and image pick-up device 1 including strobe device 2 in the first exemplary embodiment. Thus, similar structural elements are denoted with the same reference sings and the explanation will be omitted.

As FIG. 7 illustrates, strobe device 25 in the present exemplary embodiment includes, in addition to the structural elements of strobe device 2 in the first exemplary embodiment, horizontal direction angle detector 26 for detecting the inclination angle of strobe device 25 with respect to the horizontal direction.

Horizontal direction angle detector 26 and vertical direction angle detector 13 are similarly configured. Horizontal direction angle detector 26 detects the illumination direction angle in the horizontal direction of light emitter 10 (the orientation of light emitter 10).

Moreover, operation unit 27 is provided in strobe main body 8 as with the first exemplary embodiment. In the present exemplary embodiment, operation unit 27 is provided so that the user can set the angles in vertical direction A and horizontal direction F (see FIG. 4B) of light emitter 10 to desired illumination direction angles.

With reference to the first exemplary embodiment and FIG. 4B, the following briefly describes an operation in the bounce photographing mode of the image pickup device according to the present exemplary embodiment.

It should be noted that the following describes the case where a normal photographing mode is selected as the initial state of strobe device 25 and illumination direction C of light emitter 10 of strobe device 25 is oriented in photographing direction B as FIG. 4B illustrates (this state corresponds to the state where light emitter 10 is positioned at normal photographing position P4 illustrated in FIG. 4B).

The user sets a desired illumination direction angle in the bounce photographing mode for control device 14 by the following way.

Specifically, the user directs opening 16 of light emitter 10 toward the direction in which a reflection body to be illuminated by strobe light in the bounce photographing mode is located (this state corresponds to the state where light emitter 10 is positioned at bounce photographing position P5). Here, operation unit 15 causes horizontal direction angle detector 26 to detect the angle in horizontal direction F of light emitter 10 in the above state. As with the first exemplary embodiment, A/D converter 21 of control device 14 performs A/D conversion on a detection signal sent from horizontal direction angle detector 26 and corresponding to the angle in horizontal direction F of light emitter 10. A conversion value obtained through the A/D conversion is prestored as a specified value for a desired illumination direction angle in horizontal direction F of light emitter 10 in the bounce photographing mode.

The user selects the bounce photographing mode and photographs a subject in the bounce photographing mode.

Here, the user releases the shutter with the imaging lens of the image pick-up device pointed in the subject, and starts photographing. If the current angle in the horizontal direction of strobe device 25 is different from the stored specified value for the desired illumination direction angle, light emitter 10 is rotated (bounced) to have the desired illumination direction angle so that the strobe light illuminates the reflection body.

Specifically, light emitter 10 is rotated (bounced) by the way described in the first exemplary embodiment with reference to FIGS. 2 and 6. Here, horizontal direction angle detector 26 may be regarded as vertical direction angle detector 13 in the first exemplary embodiment. Thus, further explanation will be omitted.

That is, according to the present exemplary embodiment, control device 14 can immediately change the angle of light emitter 10 to the desired illumination direction angle, based on the angle in horizontal direction F of light emitter 10 (see FIG. 4B) automatically detected by horizontal direction angle detector 26, independently of the current angle of strobe device 2 (the angle of strobe device 2 before photographing).

This can immediately change the angle of light emitter 10 to the desired illumination direction angle to emit strobe light, for example, in the direction in which a wall is located. Here, the wall is a preset reflection body positioned horizontally to light emitter 10.

Moreover, according to the present exemplary embodiment, the angle in horizontal direction F of light emitter 10 can be immediately detected. This allows control device 14 to immediately change the angle of light emitter 10 to the desired illumination direction angle in horizontal direction F, independently of the current angle in horizontal direction F of strobe device 25.

Moreover, according to the present exemplary embodiment, to detect abnormal force, the horizontal direction angle detector includes detector 28 and direction detector 29. This can prevent horizontal direction variable mechanism 18 from being damaged, with basically the same operation as the operation in relation to vertical direction variable mechanism 17 described in the first exemplary embodiment.

### Third Exemplary Embodiment

With reference to FIG. 7, the following describes a strobe device according to a third exemplary embodiment of the present invention.

The strobe device in the present exemplary embodiment is different from strobe device 2 in the first exemplary embodiment and strobe device 25 in the second exemplary embodiment in the following point. In the strobe device in the present exemplary embodiment, obstacle detector 31 is provided on each of four faces but not on the side where opening 16 of light emitter 10 is located (i.e., obstacle detector 31 is provided on the top face, the bottom face, the side face on the near side, and the side face on the far side (not illustrated in the figure)). It should be noted that in terms of other configurations and functions, the strobe device in the present exemplary embodiment is basically the same as strobe device 2 in the first exemplary embodiment and strobe device 25 in the second exemplary embodiment. It should be noted that detector 28 described in the first exemplary embodiment and the second exemplary embodiment may be, of course, provided in vertical direction variable mechanism 17 or horizontal direction variable mechanism 18.

Here, obstacle detector 31 includes a component which can detect the existence of an obstacle without contact, such as an infrared sensor or a photo interrupter.

The following specifically describes an operation by the obstacle detector of the strobe device in the present exemplary embodiment.

Whether or not an obstacle (e.g., the head of a photographer or other fixed thing) is present in a direction in which obstacle detector 31 is expected to move is detected when light emitter 10 moves to have a desired angle. Here, obstacle detector 31 is provided in the position where the movement direction of light emitter 10 can be detected. Here, when obstacle detector 31 detects the obstacle, detection responsive controller 30 controls vertical direction variable mechanism 17 and/or horizontal direction variable mechanism 18 so that vertical direction variable mechanism 17 and/or horizontal direction variable mechanism 18 stop(s) the operation of light emitter 10.

This can stop light emitter 10 from moving before light emitter 10 collides with the obstacle. As a result, it is possible to secure the safety of a photographer or others and prevent the gear of variable mechanism 11 of the strobe device from being damaged or prevent the exterior surface of the strobe device from being blemished.

That is, according to the present exemplary embodiment, obstacle detector 31 can detect an obstacle before light emitter 10 collides with the obstacle, and stop driving light emitter 10 or move light emitter 10 in the opposite direction. This can further prevent a person such as a photographer from being placed in danger or decrease the danger and prevent variable mechanism 11 from being damaged.

It should be noted that the above exemplary embodiment takes as an example obstacle detector 31 for detecting the existence of an obstacle without contact, such as an infrared sensor or a photo interrupter. However, other examples are also possible. For instance, obstacle detector 31 may be an obstacle detector which detects an obstacle through contact with the obstacle, such as a pressure sensitive sensor or a detection switch. Moreover, obstacle detector 31 may be an obstacle detector which can detects the existence of an obstacle by approaching the obstacle without contact. This can improve the versatility of strobe device 2.

It should be noted that a strobe device and an image pick-up device including the strobe device in the present invention are not limited to the exemplary embodiments, and can be, of course, changed in various aspects without departing from the scope of the present invention.

For instance, in the embodiments, operation units 15 and 27 of strobe device 2 are provided in strobe main body 8. However, other configurations are also possible. For instance, operation units 15 and 27 may be included in light emitter 10 or image pick-up device 1.

Moreover, in the exemplary embodiments, light emitter 10 is positioned at bounce photographing position P2 by inclining strobe device 2 (or image pick-up device 1) and light emitter 10. The angle of light emitter 10 at that time is detected by vertical direction angle detector 13 to set a desired illumination direction angle. However, other examples are also possible. For instance, a user may set a desired illumination direction angle by directly inputting the angle of light emitter 10 through operation units 15 and 27. Furthermore, control devices 14 and 23 may preset a desired illumination direction angle.

Moreover, in the exemplary embodiments, the maximum rotation range of vertical direction variable mechanism 17 is 180 degrees. However, other rotation ranges are also possible. For instance, the maximum rotation range of vertical direction variable mechanism 17 may be 90 degrees. Also in this case, by combining vertical direction variable mechanism 17 and horizontal direction variable mechanism 18, it is possible to rotate light emitter 10 around lateral axis X from a normal illumination position and change the angle in the vertical direction of light emitter 10 by at most 180 degrees, as with the exemplary embodiments. That is, if vertical direction variable mechanism 17 should be rotated in the range from 90 degrees to 180 degrees, the above rotation can be achieved if horizontal direction variable mechanism 18 can rotate by 180 degrees in a clockwise direction and in a counterclockwise direction.

Moreover, in the exemplary embodiments, vertical direction angle detector 13 detects the angle in vertical direction A of light emitter 10 and control device 14 detects the inclination angle of light emitter 10. However, other examples are also possible. For instance, vertical direction angle detector 13 may detect the angle in vertical direction A of light emitter 10, and detect the inclination angle of light emitter 10 based on the detection value.

Moreover, in the above exemplary embodiments, the emission direction of strobe light is set to be always oriented in a desired direction appropriate for bounce photographing. However, other examples are also possible. For instance, the combination of a range sensor and a light receiving sensor for receiving strobe light from light emitter 10 may be applied to a range measuring unit for measuring a distance to a subject or a reflection body. By so doing, the illumination direction of the strobe light may be controlled so as to be always oriented in the direction in which the subject is present or the reflection body is located.

Moreover, in the exemplary embodiments, the inclination angle of light emitter 10 is changed with respect to strobe main body 8. However, other configurations are also possible. For instance, reflector 9a housing flash discharge tube 9 of light emitter 10 illustrated in FIG. 2 is set to be oriented in a desired direction so that strobe light illuminates the reflection body.

Moreover, in the exemplary embodiments, strobe main body 8 includes A/D converter 21, arithmetic unit 22, and controller 23 in control device 14. However, other configurations are also possible. For instance, a part or all of AID converter 21, arithmetic unit 22, and controller 23 included in control device 14 may be provided in image pick-up device 1. In this case, connecting strobe device 2 and image pick-up device 1 allows control device 14 to perform control.

Moreover, in the exemplary embodiments, vertical direction angle detector 13 and horizontal direction angle detector 26 each include a variable resistor, and detector 28 also performs control using information (a resistance value) on the variable resistor. However, other configurations are also possible. For instance, vertical direction angle detector 13 and horizontal direction angle detector 26 may take an independent system for detecting a torque change in variable mechanism 11. In this case, vertical direction angle detector 13 and horizontal direction angle detector 26 may take different systems. Likewise, detector 28 may take another system.

As described above, the present invention includes: a strobe main body; a light emitter rotatably coupled to the strobe main body; a variable mechanism capable of changing an illumination direction angle of the light emitter; and a driver that drives the variable mechanism, in which the driver includes: a detector that detects that abnormal force is applied to the variable mechanism; and a detection responsive controller that controls the driver based on the abnormal force detected by the detector.

According to this configuration, the detection responsive controller controls the operation of the light emitter so as to prevent the driver from being broken when the abnormal force is applied to the light emitter. This can prevent the light emitting device from being damaged, thereby achieving a strobe device with excellent safety and reliability.

In the strobe device according to the present invention, the detector may further include a direction detector that detects a direction in which the abnormal force is applied to the variable mechanism.

According to this configuration, the detector can detect the direction in which the abnormal force is applied. This can control the light emitter in a direction in which the variable mechanism is not to be damaged. As a result, the light emitter can be prevented from damage.

In the strobe device according to the present invention, when the detector detects the abnormal force with the driver not in operation, the detection responsive controller may control the driver so that the driver drives the light emitter in the direction in which the abnormal force is applied.

According to this configuration, the detection responsive controller causes the driver to drive the light emitter in the direction in which the abnormal force is applied. This can prevent the variable mechanism from being damaged.

Moreover, in the strobe device according to the present invention, when the detector no longer detects the abnormal force, the detection responsive controller may control the driver so that the driver stops driving the light emitter.

According to this configuration, when the detector no longer detects the abnormal force, the detection responsive controller stops driving the light emitter. By so doing, when a photographer manually changes the bounce angle of the light emitter, the driver can assist the change. As a result, the photographer can adjust the angle of the light emitter to a desired bounce angle with the small force.

Moreover, in the strobe device according to the present invention, when the detector detects the abnormal force with the driver in operation, the detection responsive controller may control the driver so that the driver limits a movement of the light emitter in a direction in which the light emitter is moving.

According to this configuration, for example, when the light emitter collides with an obstacle, the detection responsive controller can control so that the driver stops operating or moves in the opposite direction. This can prevent a person such as a photographer from being placed in danger or decrease the danger and prevent the variable mechanism from being damaged.

Moreover, the present invention may include: a strobe main body; a light emitter rotatably coupled to the strobe main body; a variable mechanism capable of changing an illumination direction angle of the light emitter; and a driver that drives the variable mechanism, in which the driver includes: an obstacle detector that detects that the light emitter is going to collide with an obstacle; and a detection responsive controller that controls the driver when the obstacle detector detects that the light emitter is going to collide with the obstacle.

According to this configuration, the obstacle detector can detect an obstacle before the light emitter collides with the obstacle. This can prevent a person such as a photographer from being placed in danger or decrease the danger and prevent the variable mechanism from being damaged. As a result, a strobe device with excellent safety and reliability can be achieved.

Moreover, in the strobe device according to the present invention, when the obstacle detector detects an obstacle with the driver in operation, the detection responsive controller may control the driver so that the driver limits a movement of the light emitter in a direction in which the light emitter is moving.

According to this configuration, the obstacle detector can detect an obstacle before the light emitter collides with the obstacle, and stop driving the light emitter or move the light emitter in the opposite direction. This can further prevent a person such as a photographer from being placed in danger or decrease the danger and prevent the variable mechanism from being damaged.

Moreover, an image pick-up device in the present invention may include the above strove device. This can not only improve safety but also achieve an image pick-up device with excellent reliability.

### INDUSTRIAL APPLICABILITY

The present invention can operate a light emitter in an appropriate direction when the abnormal force is applied to the light emitter. Thus, the present invention is applicable to uses in which prevention of damage to, for example, the variable mechanism of a strobe device is expected.

Moreover, in the present invention, when a user manually changes a bounce angle, a driver assists the change. Thus, the present invention is also useful in uses in which adjustment to a desired bounce angle with the small force is expected.

### REFERENCE MARKS IN THE DRAWINGS

1 image pick-up device
2, 25 strobe device
3 photographing function unit
4, 22 arithmetic unit
5 display unit
6, 15, 27 operation unit
8 strobe main body
8a top face
8b bottom face
8c front
8d back
9 flash discharge tube
9a reflector
10 light emitter
10a face
11 variable mechanism
12 driver
13 vertical direction angle detector
14 control device
16 opening
17 vertical direction variable mechanism
18 horizontal direction variable mechanism
19 vertical direction driver
20 horizontal direction driver
21 A/D converter
23 controller
26 horizontal direction angle detector
28 detector
29 direction detector
30 detection responsive controller
31 obstacle detector

1. A strobe device comprising:
a strobe main body;
a light emitter rotatably coupled to the strobe main body;
a variable mechanism capable of changing an illumination direction angle of the light emitter; and
a driver that drives the variable mechanism,
wherein the driver includes:
a detector that detects that abnormal force is applied to the variable mechanism; and
a detection responsive controller that controls the driver based on the abnormal force detected by the detector.

2. The strobe device according to claim 1,
wherein the detector further includes a direction detector that detects a direction in which the abnormal force is applied to the variable mechanism.

3. The strobe device according to claim 2,
wherein when the detector detects the abnormal force with the driver not in operation, the detection responsive controller controls the driver so that the driver drives the light emitter in the direction in which the abnormal force is applied.

4. The strobe device according to claim 3,
wherein when the detector no longer detects the abnormal force, the detection responsive controller controls the driver so that the driver stops driving the light emitter.

5. The strobe device according to claim 1,
wherein when the detector detects the abnormal force with the driver in operation, the detection responsive controller controls the driver so that the driver limits a movement of the light emitter in a direction in which the light emitter is moving.

6. A strobe device comprising:
a strobe main body;
a light emitter rotatably coupled to the strobe main body;
a variable mechanism capable of changing an illumination direction angle of the light emitter; and
a driver that drives the variable mechanism,
wherein the driver includes:
an obstacle detector that detects that the light emitter is going to collide with an obstacle; and
a detection responsive controller that controls the driver when the obstacle detector detects that the light emitter is going to collide with the obstacle.

7. The strobe device according to claim 6,
wherein when the obstacle detector detects an obstacle with the driver in operation, the detection responsive controller controls the driver so that the driver limits a movement of the light emitter in a direction in which the light emitter is moving.

8. An image pick-up device comprising the strobe device according to claim 1.

9. An image pick-up device comprising the strobe device according to claim 6.
